(19) United States
(12) Patent Application Publication
(10) Pub. No.: US 2019/0297197 A1
(43) Pub. Date: Sep. 26, 2019

(54) METHOD FOR EDITING PHOTO FILE USING GPS COORDINATE INFORMATION

(71) Applicant: Young Sik MOON, Seoul (KR)

(72) Inventor: Young Sik MOON, Seoul (KR)

(21) Appl. No.: 16/464,999

(22) PCT Filed: Sep. 4, 2017
(86) PCT No.: PCT/KR2017/009658

§ 371 Date: May 29, 2019

(30) Foreign Application Priority Data
Nov. 30, 2016 (KR) 10-2016-0161136

(51) Int. Cl. H04N 1/00; G06F 16/587

(52) U.S. Cl. CPC H04N 1/00167; H04N 1/00177; H04N 1/00151; G06F 16/587

(57) ABSTRACT

A photo editing method using GPS coordinate information is disclosed. The present invention comprises the steps of: allowing a photo file editing server to receive at least one photo file through a user terminal; allowing the photo file editing server to receive a designated range of photo files of a specific time zone from the user terminal; allowing the photo file editing server to extract the date and GPS coordinate information of a photo so as to include a photo file included in the range of the specific time zone; and allowing the photo file editing server to arrange the selected photo file in a background draft, which is set in GPS coordinate information proximate to the extracted GPS coordinate information of the photo file among background drafts stored in a draft database.

### TECHNICAL FIELD

The present invention relates to a photo file editing method using GPS coordinate information, and more particularly, to a photo file editing method using GPS coordinate information which makes easy to select a draft by arranging a photo file in a background draft associated with a photographing site in a specific time band and gives a sense of realism and a touch to a user due to a photo in which a plurality of photo files are arranged in the background draft.

### BACKGROUND ART

Due to the advent of various devices, such as digital cameras and camera phones, which can capture digital photos and the popularization of the internet, related industries have rapidly grown in the world markets as well as in the Korean markets.

In particular, since the digital cameras convert images formed by photographing lenses to digital signals and store the images in memories, they require no films.

The capacities of the memories of the digital cameras are limited, and it is difficult for common people who do provide various functions or are not accustomed to the functions of cameras to edit photos In order to overcome the difficulty of the photo editing, various editing programs, such as Photoshop, album dedicated programs, and album automatic editing programs are provided.

However, although the completeness of the photos can be increased when, among the editing programs, the editing programs such as Photoshop are used, much time (for example, one to three days) is necessary to edit several photo files in one photo. In addition, when a beginner user who is not accustomed in the editing tools of Photoshop has a difficulty of learning the editing tools.

Further, when an album dedicated program is used, a result in which a photo is arranged in a draft is provided, but because a user changes the photos by using various designs and arranges the photos in the changed draft, the completeness of the photos can be increased, but much time (for example, 2 to 8 hours) are required for changing the draft.

Further, only the drafts provided by the manufacturers when the album automatic editing programs are used, it takes little time to edit the photos but the operations are made only in a specific time frame so that there is no diversity and completeness is low.

Further, when the program is used, it takes long time to find, among many photo files, the photo files desired by a user, for example, the photo files captured in a specific time band. Accordingly, when the photo files in a specific time band are arranged in one photo, there is a difficulty of having to selecting the photos with the help of the memories at the photographing time point.

Further, since almost of the conventional designs are edited for albums by using the backgrounds having illustrations or specific patterns, the photos captured in the tourist sites or picnics (amusement parks, palaces, and parks) in a background draft having a specific pattern, that is, a background draft which does not match the photos so that the sense of realism or the motion of the photos deteriorates, the seasons are not considered, and the completeness and the satisfaction of the photos deteriorate by using the limited drafts.

### DETAILED DESCRIPTION OF THE INVENTION

### Technical Problem

The present invention provides a photo file editing method by using GPS coordinate information which makes easy to select a draft by arranging a photo file in a background draft associated with a photographing site in a specific time band and gives a sense of realism and a touch to a user due to a photo in which a plurality of photo files are arranged in the background draft.

### Technical Solution

In accordance with an aspect of the present invention, there is provided a photo editing method using GPS coordinate information, the method using a photo file editing server including a draft database which stores a draft having a structure in which a plurality of photo files are arranged in one photo, the method including: receiving, via an information communication network, one or more photo files selected by a user terminal, by the photo file editing server; receiving a range of, among the received one or more photo files, photo files captured in a specific time band from the user terminal, by the photo file editing server; extracting a date and GPS coordinate information contained in the received one or more photo files, and selecting a photo file pertaining to the received range of the specific time band of the extracted date, by the photo file editing server; and arranging the selected photo file in, among background drafts stored in the draft database, a background draft set to GPS coordinate information, which is closed to the extracted GPS coordinate information, and providing the arranged photo file, by the photo file editing server.

The selecting of the photo file may include: automatically selecting, among the photo files pertaining to the received range of the specific time band, a photo file which is to be used for editing, according to a preset selection reference condition, or selecting a photo file selected through the user terminal, by the photo file editing server.

The draft database may store a background draft in which an image which matches with arbitrary GPS coordinate information to express a site of the corresponding GPS coordinate information is included in an arbitrary area, and the providing of the arranged photo file may include: searching for GPS coordinate information which is closest to a longitude, a latitude, and a direction of the extracted GPS coordinate information from the draft database, matching the discovered GPS coordinate information, and arranging the selected photo file in the stored background draft.

The receiving of the one or more photo files may include: receiving a photo file captured through an electronic terminal equipped with a GPS receiver and a camera from the user terminal, or receiving the captured photo file from the user terminal equipped with the GPS receiver and the camera.

The providing of the arranged photo file may include: transmitting the photo in which the photo file is arranged in the background draft to the user terminal via the information communication network.

The draft database may store, for each season, a background draft in which an image which matches with arbitrary GPS coordinate information to express a site of the corresponding GPS coordinate information is included, and the providing of the arranged photo file may include: searching for GPS coordinate information which is closest to the extracted GPS coordinate information from the draft database, matching the discovered GPS coordinate information, and arranging the selected photo file in, among the stored background drafts, a background draft on which a determined season is reflected, on the basis of the extracted date.

The draft database may store a background draft in which an image which matches with arbitrary GPS coordinate information to express a site of the corresponding GPS coordinate information is included and guide information for explaining a site of the background draft, and the providing of the arranged photo file may include: providing the guide information for explaining a site of the GPS coordinate information to an arbitrary area of the background draft in which the selected photo file is arranged.

In accordance with another aspect of the present invention, there is provided a photo editing method using GPS coordinate information, the method being used for a photo file editing apparatus having a data storage unit which stores background drafts, the method including: receiving a range of, among one or more photo files, photo files captured in a specific time band, by a central processing unit; extracting a date and GPS coordinate information contained in the one or more photo files, and selecting a photo file pertaining to the received range of the specific time band of the extracted date, by the central processing unit; and arranging the selected photo file in, among background drafts stored in the data storage unit, a background draft set to GPS coordinate information, which is closed to the extracted GPS coordinate information, and providing the arranged photo file, by the central processing unit.

The selecting of the photo file may include: displaying a photo file pertaining to the received range of the specific time band on a thumbnail screen, by the central processing unit; and automatically selecting, among the photo files displayed on the reduction image screen, a photo file which is to be used for editing, according to a preset selection reference condition, or selecting a photo file selected through the user terminal, by the central processing unit.

The data storage unit may store a background draft in which an image which matches with arbitrary GPS coordinate information to express a site of the corresponding GPS coordinate information is included in an arbitrary area, and the providing of the arranged photo file may include: searching for GPS coordinate information which is closest to a longitude, a latitude, and a direction of the extracted GPS coordinate information from the draft database, matching the discovered GPS coordinate information, arranging the selected photo file in the stored background draft, and displaying the arranged photo file on a screen.

The data storage unit may store, for each season, a background draft in which an image which matches with arbitrary GPS coordinate information to express a site of the corresponding GPS coordinate information is included, and the providing of the arranged photo file may include: searching for GPS coordinate information which is closest to the extracted GPS coordinate information from the draft database, matching the discovered GPS coordinate information, and arranging the selected photo file in, among the stored background drafts, a background draft on which a determined season is reflected, on the basis of the extracted date.

The data storage unit may store a background draft in which an image which matches with arbitrary GPS coordinate information to express a site of the corresponding GPS coordinate information is included and guide information for explaining a site of the background draft, and the providing of the arranged photo file may include: providing the guide information for explaining a site of the GPS coordinate information to an arbitrary area of the background draft in which the selected photo file is arranged.

### Advantageous Effects of the Invention

An embodiment of the present invention, makes easy to select a draft by arranging a photo file in a background draft associated with a photographing site in a specific time band and gives a sense of realism and a touch to a user due to a photo in which a plurality of photo files are arranged in the background draft. In particular, since the photo files captured at a main tourist site are arranged in a background draft which expresses arbitrary GPS coordinate information, that is, the feature of the main tourist site, various designs can be applied in consideration of the sense of realism and the seasons and albums can be easily made and utilized by any user.

### DESCRIPTION OF THE DRAWINGS

FIG. 1 is a block diagram illustrating a photo file editing system according to an embodiment of the present invention.

FIG. 2 is a block diagram illustrating a photo file editing server illustrated in FIG. 1.

FIG. 3 is an operation flowchart illustrating a photo file editing method using GPS coordinate information in a photo file editing system according to an embodiment of the present invention.

FIG. 4 is a view illustrating attribute information of an exchangeable image file format (EXIF) applied to the present invention.

FIG. 5 is a block diagram illustrating a photo file editing apparatus according to another embodiment of the present invention.

FIG. 6 is an operation flowchart illustrating a photo file editing method using GPS coordinate information in a photo file editing apparatus according to another embodiment of the present invention.

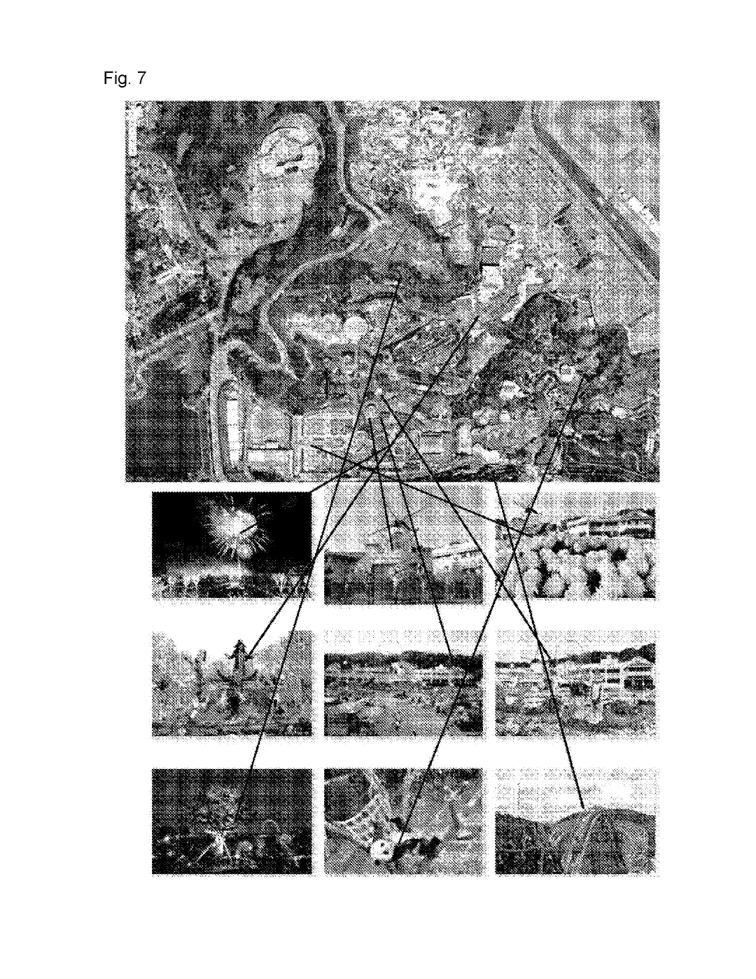

FIG. 7 is an exemplary view of a screen illustrating an image used as a background draft for a GPS coordinate.

FIGS. 8A to 8C are views illustrating screens in which a photo file is arranged in a background draft, to which the present invention is applied.

FIG. 9 is a view illustrating a screen in which guide information is displayed in a photo in which a photo file is arranged in a background draft.

FIG. 10 is a view illustrating an image acquired for a photographing direction of a camera.

FIGS. 11A to 11D are views illustrating background times set for seasons.

### BEST MODE

Hereinafter, exemplary embodiments of the present invention will be described in detail with reference to the accompanying drawings.

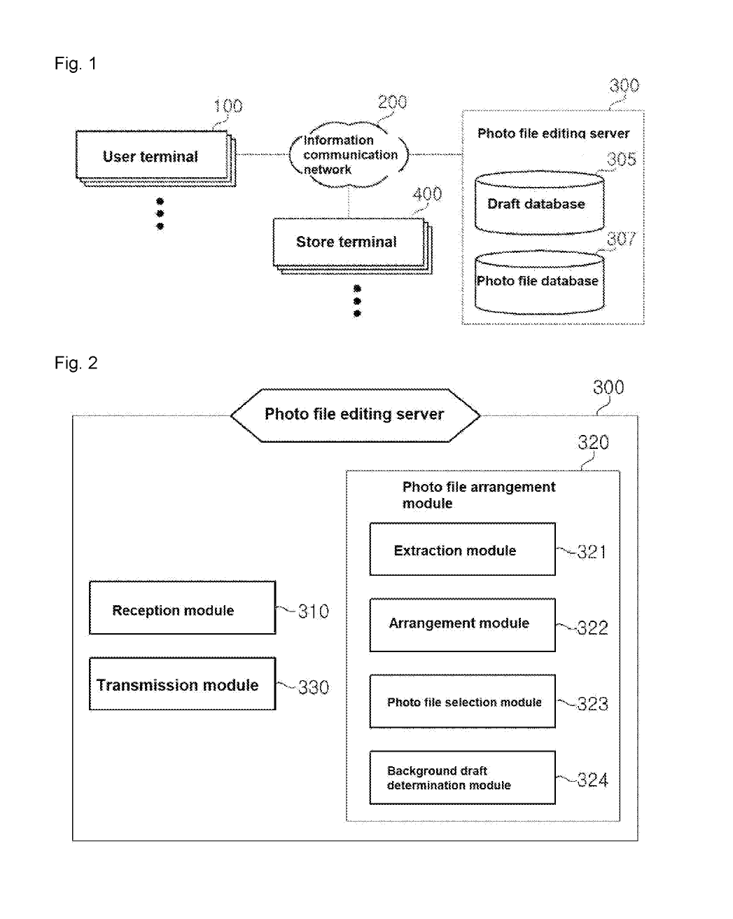

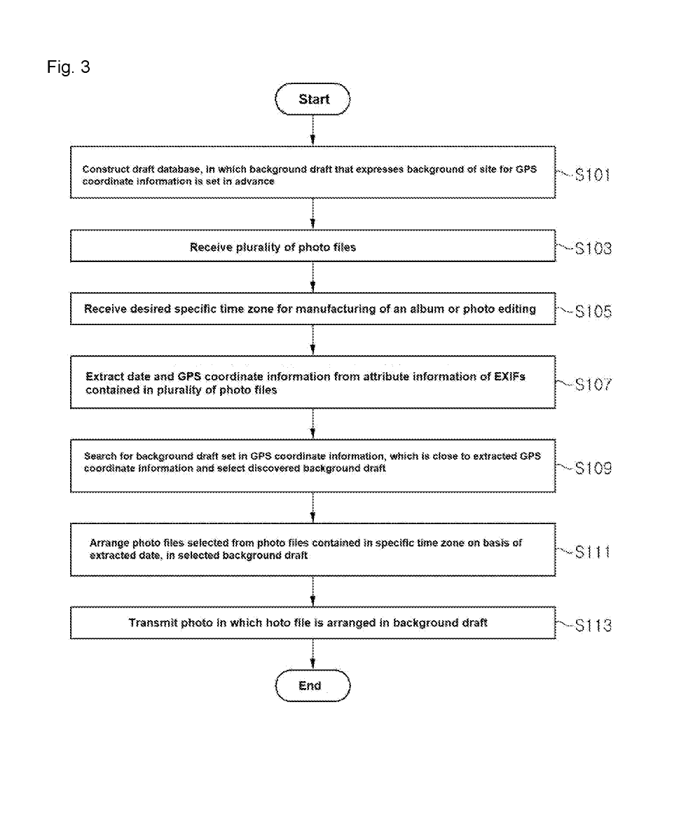

A photo file editing system according to an embodiment of the present invention will be described with reference to FIGS. 1 and 2 as follows.

FIG. 1 is a block diagram illustrating a photo file editing system according to an embodiment of the present invention. FIG. 2 is a block diagram illustrating a photo file editing server illustrated in FIG. 1.

Referring to FIG. 1, the photo file editing system according to the embodiment of the present invention includes a user terminal 100 which is a requester of information, a photo file editing server 300 which is a supplier of information, and an information communication network 200 for interfacing the user terminal 100 and the photo file editing server 300 by wire or wirelessly.

The photo file editing system according to the embodiment of the present invention may further include a store terminal 400 installed in a store, for example, a store which edits a photo, a store which prints a photo, or a store which provides a draft. The store terminal 400 includes a personal computer, and may transmit a draft manufactured by a store manager to the photo file editing server 300. Further, the store terminal 400 may request the photo file editing server 300 to edit a photo file or download a draft in which a photo file is to be arranged from the photo file editing server 300.

Although the user terminal 100 is set to include a mobile communication terminal for wireless internet communication as well as a personal computer such as a notebook computer, the present invention is not limited thereto. The user terminal 100 may receive a photo file captured through an electronic terminal equipped with a GPS receiver and a camera or may be equipped with a GPS receiver and a camera.

In particular, the user terminal 100 transports a plurality of photo files to the photo file editing server 300 through an information communication network 200 to make a request for manufacturing of an album or editing of a photo file. The user terminal 100 may receive a photo file captured by a digital photographing device such as a digital camera, on which a GPS receiver is mounted, through a communication cable, for example, a universal serial bus (USB). When the user terminal 100 is equipped with a GPS receiver and a camera and stores a plurality of photo files, it may transmit the plurality of photo files stored in the user terminal 100 to the photo file editing server 300 directly through the information communication network 200.

The information communication network 200 includes an internet network which uses a TCP/IP protocol for wired connection and a WAP protocol for wireless connection, an internal network, and the like. Here, the user terminal 100 and the store terminal 400 are connected to the photo file editing server 300 through the information communication network 200 (for example, an internet network).

The photo file editing server 300 includes a draft database 305 which stores a draft having various arrangement structure, and receives a photo file from the user terminal 100 which is connected to a communication through the information communication network 200, and arranges a photo file selected from, among the received photo files, photo files of a specific time zone selected from or input by the user terminal 100 in a background draft which matches a photographing site and provides the arranged photo file to the user terminal 100.

The draft database 305 stores a background draft which expresses a background of a site for GPS coordinate information, at which the corresponding GPS coordinate information is located. Further, the draft database 305 may further store a background draft for expressing a season, a theme, an event, and the like. Further, the draft database 305 may match a background draft containing an image which expresses a site of the corresponding coordinate information for a season with arbitrary GPS coordinate information and may store the background draft for the season. Further, the draft database 305 may match a background draft containing an image which expresses a site of the corresponding coordinate information for a season with arbitrary GPS coordinate information, and guide information for explaining a site of the background draft, and may store the background draft for the season and the guide information.

Referring to FIG. 2 again, the photo file editing server 300 includes a reception module 310, a photo file arrangement module 320, and a transmission module 330.

The reception module 310 receives a plurality of photo files which is to be used for manufacturing of an album or photo editing from the user terminal 100. The photo file received in this way is temporarily stored in the photo file database 307. Then, although the number of the photo files may be the number of photo files which are to be designed in one photo or may be the number of photo files which are to be arranged in a desired number of pages when an album is manufactured, the present invention is not limited thereto.

Further, the reception module 310 may receive a background draft together with GPS coordinate information from the store terminal 400. The background draft received in this way is stored in the draft database 305. In addition, the reception module 310 may also receive a photo file, which is to be used for editing, from the store terminal 400.

The program file arrangement module 320 arranges a photo file, which is selected from, among the photo files received through the reception module 310, photo files captured in a specific time zone, in a background draft which expresses the background of a captured site. Here, the background draft may be selected by the user terminal 100 at the same time when the photo file are selected, but may also be automatically selected.

In more detail, the photo file arrangement module 320 includes an extraction module 321, an arrangement module 322, a photo file selection module 323, and a background draft determination module 324.

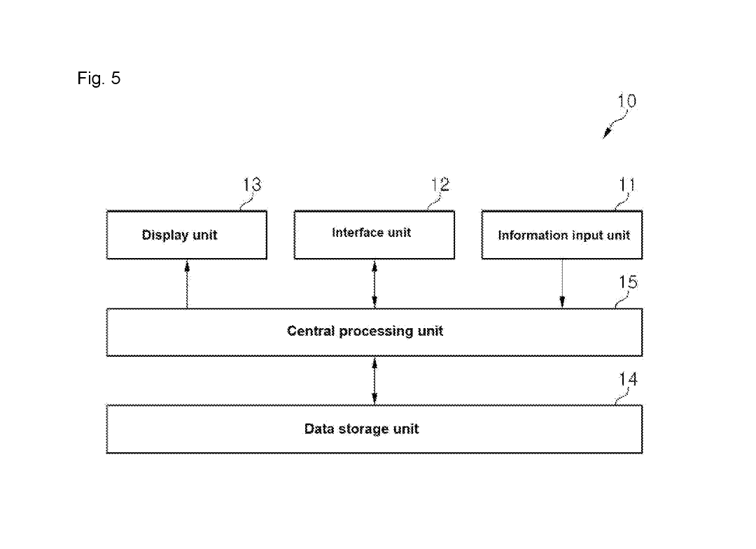

The extraction module 321 extracts the date of an original copy and GPS coordinate information from detailed information of the photo file received by the reception module 310, that is, attribute information of an exchangeable image file format (hereinafter, referred to as ‘EXIF’), which is joint photographic experts group (JPEG) attribute information employed by a digital camera. As illustrated in FIG. 4, the attribute information of the EXIF is detailed additional information, such as a camera maker, a camera model, an image editor (software), a date/time of an original copy (a), an EXIF version, a shoot date/time, an actual image size of a photo uploaded on a website, an exposure time, an exposure program, a focal length of a lens, an F-number, whether a flash is used, and a GPS coordinate information including a longitude and a latitude illustrated in FIG. 4B and a direction illustrated in FIG. 4C.

Here, because it is widely known that EXIF attribute information format of JPEG is used by a digital camera equipped with a GPS receiver and freeware for identifying EXIF attribute information has been public, a data/time of an original copy and GPS coordinate information may be extracted even only through simple coding, by which the date/time of the original copy and the GPS coordinate information may be read from the EXIF attribute information.

As an example, the shoot date/time may be described in the sequence of year/month/date, a.m. or p.m./hour/minute/second. As an example, as can be identified in FIG. 4A, the shoot date/time may be expressed as 2006-09-1 p.m. 4:02:02.

Further, in the expression of information of a GPS, GPS Latitude, GPS Longitude Reference, GPS Longitude and the like may be expressed, and as can be identified in FIG. 4B, as an example, may be expressed as 35. 34′ 48.05′, East longitude, and 126. 40′ 4.8, respectively.

Further, the GPS coordinate information in the illustrated direction may be expressed by a GPS image direction, and as can be identified in FIG. 4C, as an example, may be expressed as 307.173.

The arrangement module 322 may arrange the photo files in an ascending order or a descending order on the basis of a date extracted by the extraction module 321.

The photo file selection module 323 selects a photo file, which is to be used for manufacturing of an album or photo editing, from the photo files contained in a time range of the photo files captured in a specific time zone set by the user terminal 100 on the basis of the date extracted by the extraction module 321.

In more detail, the photo file selection module 323 may automatically select a photo file, which is to be used for manufacturing of an album or photo editing, from the photo files captured in a specific time zone, according to a preset selection reference condition, change the photo file automatically selected by the user terminal 100, or receive arranged photo files from the user terminal 100 such that a desired photo file is selected and manually select a photo file, which is to be used for manufacturing of an album or photo editing.

The photo file selected in this way is arranged in a background draft determined by the background draft determination module 324.

The background draft determination module 324, on the basis of GPS coordinate information of the photo files contained in a specific time zone, which are to be arranged in the background draft, searches for the closest GPS coordinate information from the draft database 305, and determines the background draft set in the discovered GPS coordinate information as a background time of the photo files contained in the specific time zone. Then, the background draft may be a background draft selected by the user terminal 100 according to the taste of a user or a background draft employed by a server manager, but preferably, may be a background draft which matches a photographing site in a specific time zone to give the user a sense of realism of the photo or touch the heart of the user. In particular, a tourist site or a site for a family picnic may be easily identified even only from a background draft through a plurality of photo files arranged in a background draft which matches the photos captured at the tourist site or the site for a family picnic (an amusement park, a palace, or a park).

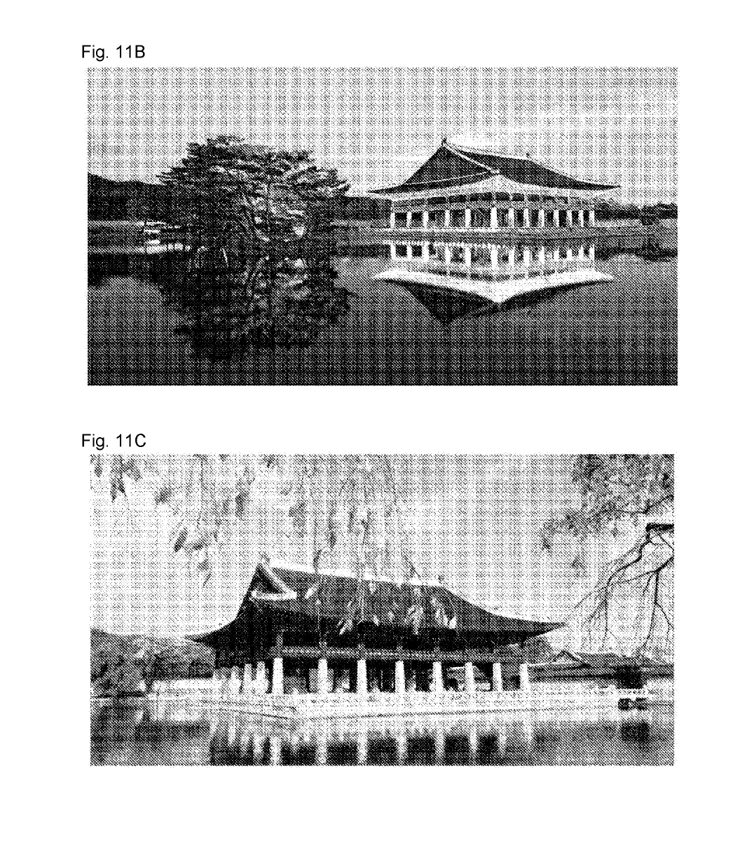

Further, as illustrated in FIG. 10, the background draft determination module 324 may determine a background draft in a direction, which is closest to the direction contained in the GPS coordinate information in consideration of the fact that the acquired images are different according to a photographing direction of the camera. That is, the background draft determination module 324 determines a background draft in consideration of the direction contained in the GPS coordinate information as well as the location.

Moreover, the background draft determination module 324 determines a background draft set to a season of a date in the EXIF information by using the date or determines a background time zone, which is closest to the corresponding date when a plurality of background drafts are set for seasons.

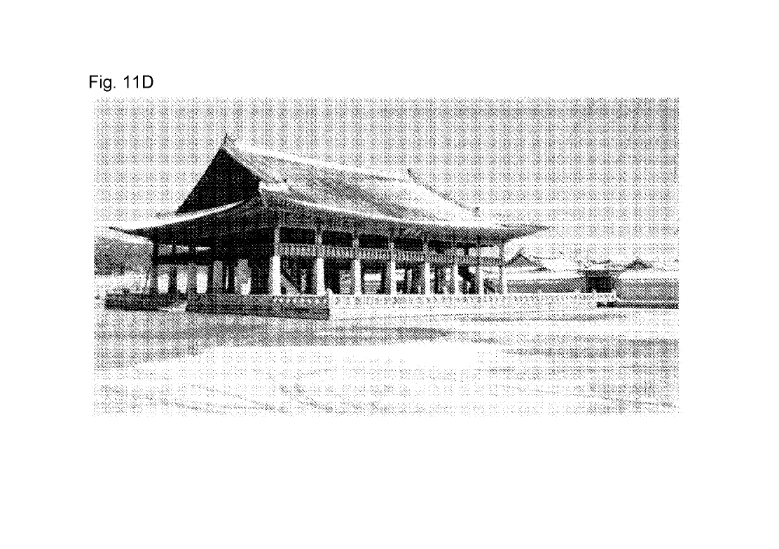

As illustrated in FIGS. 11A to 11D, the background draft determination module 324 selects one background draft from a background draft of spring illustrated in FIG. 11A, a background draft of summer illustrated in FIG. 11B, a background draft of autumn illustrated in FIG. 11C, and a background draft of winter illustrated in FIG. 11D even in the case of the same photographing site (Gyeonghoe-Ru).

For example, when the location contained in the EXIF information is coordination information of Gyeonghoe-Ru and the date contained in the EXIF is Mar. 10, 2015, the background draft determination module 324 may select FIG. 11A that is a background draft corresponding to spring, which is the season of the corresponding date (10 March) from FIGS. 11A to 11D, and may select a background draft, which is closest to the date, from the background drafts corresponding to spring.

Although it is described in the present embodiment that a background draft is determined on the basis of a date contained in the EXIF information and a location and a direction contained in the GPS coordinate information, a background draft, which matches the weather, may be determined by collecting weather information of the date contained in the EXIF information, and it is apparent that a draft employed by the server manager according to the number of the photo files, which are to be reflected, may be determined as a background draft.

The photo file selection module 323 and the background draft determination module 324 of the photo file arrangement module 320 arrange the photo files captured in the specific time zone in the background draft. The photo file arrangement module 320 adjusts the size of the photo file according to the arrangement structure of the draft and arranges the photo file.

Then, the photo file is arranged in a preliminary draft in addition to the selected background draft. The photo files arranged in the preliminary draft may be photo files selected by the photo file selection module 323, photo files within a predetermined time period (for example, 10 minutes) with reference to the selected photo files, or photo files after a predetermined time period (for example, 10 minutes).

In this way, if the photo file is arranged in the background draft, the transmission module 330 transmits the photo file arranged in the background draft to the user terminal 100. Further, the transmission module 330 transmits the photo file arranged in the preliminary draft to the user terminal 100.

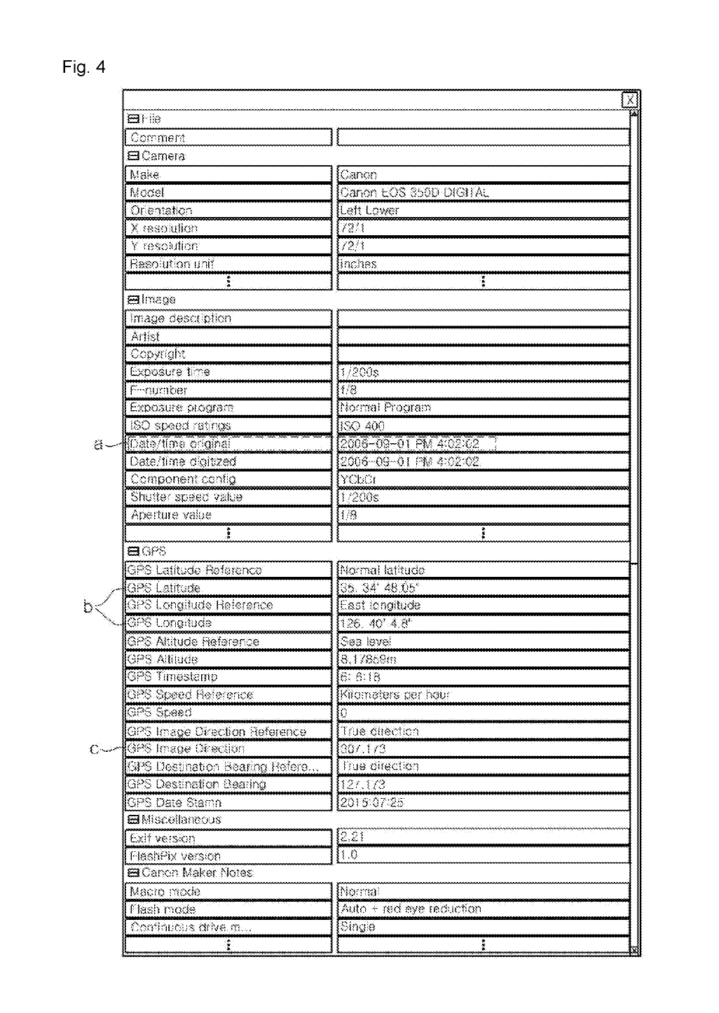

A photo editing method using GPS coordinate information in a photo file editing system according to an embodiment of the present invention will be described with reference to FIG. 3 as follows.

FIG. 3 is an operation flowchart illustrating a photo file editing method using GPS coordinate information in a photo file editing system according to an embodiment of the present invention.

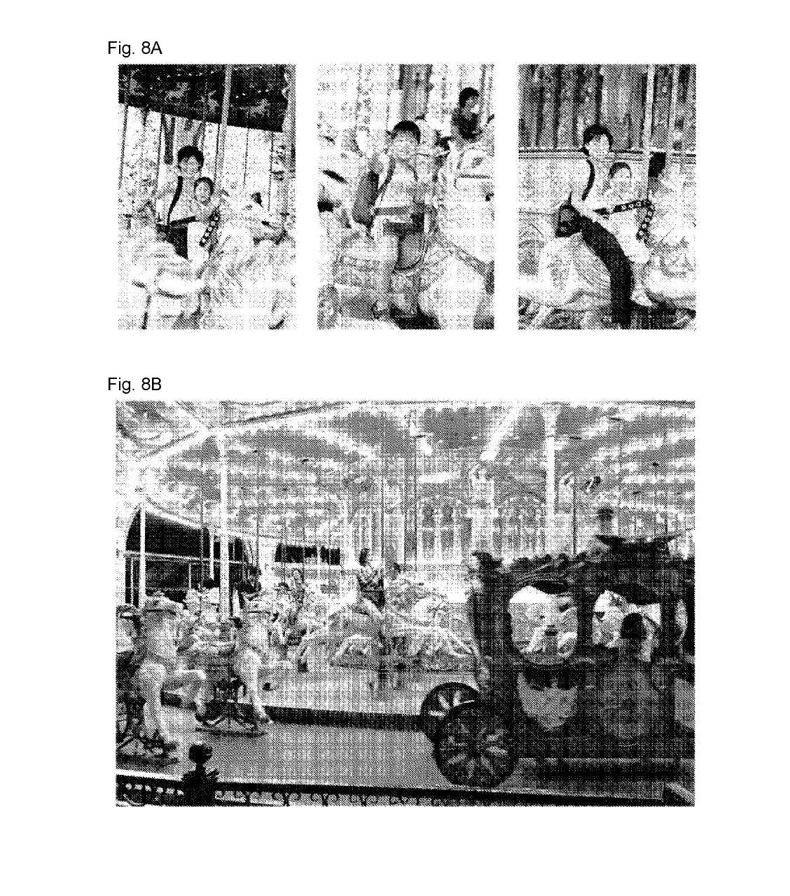

Referring to FIG. 3, the photo file editing server 300 has already constructed a draft database 305, in which a background draft that expresses a background of a site for GPS coordinate information is set (S101). The background draft stored in the draft database 305 has a structure in which several photo files may be arranged in one photo, and as illustrated in FIG. 7, a background draft which matches a sense of realism of the photographing site is set.

The photo file editing server 300 receives a plurality of photo files for manufacturing of an album or photo editing from the user terminal 100 which accesses a communication through the information communication network 200 (S103). Then, the received photo file is a photo file that is to be used in one photo or a photo file that is to be used in a background draft for a page during manufacturing of an album, and is stored in the photo file database 307.

The photo file editing server 300 receives a desired specific time zone (for example, May 1, 2016 to May 5, 2016) for manufacturing of an album or photo editing from the user terminal 100 (S105).

The photo file editing server 300 extracts a date and GPS coordinate information from attribute information of the EXIFs contained in the plurality of photo files received in step S103 (S107). Step S107 is not necessarily performed after step S105, and may also be performed after step S103 or may be performed if before step S109.

The photo file editing server 300 searches for a background draft set in GPS coordinate information, which is close to the GPS coordinate information extracted from the photo files of the specific time zone, from the draft database 305, and selects the discovered the background draft (S109).

Here, although it is described that a background draft set in the GPS coordinate information that is close to the GPS coordinate information is selected when the background draft is selected, it is preferable that a background draft, which is close to a season containing a date or the date, as well as the GPS coordinate information is determined.

Thereafter, the photo file editing server 300 arranges a photo files selected from the photo files contained in the specific time zone automatically or manually through the user terminal 100, on the basis of the extracted date, in the selected background draft (S111).

The photo file editing server 300 transmits a photo in which the photo file is arranged in the background draft, that is, one photo or a photo which is to be arranged over one page or two pages of an album, to the user terminal (S113).

By doing this, a sense of realism or a touch of the photo given to the user who requests manufacturing of an album or the user who requests editing of a photo can be doubled by arranging a photo file captured in a specific time zone in a background draft which expresses the background of a photographing site to provide the arranged photo file. Further, a time period until the photo file captured in the specific time zone during manufacturing of an album is arranged in the background draft favored by the user and is identified can be reduced.

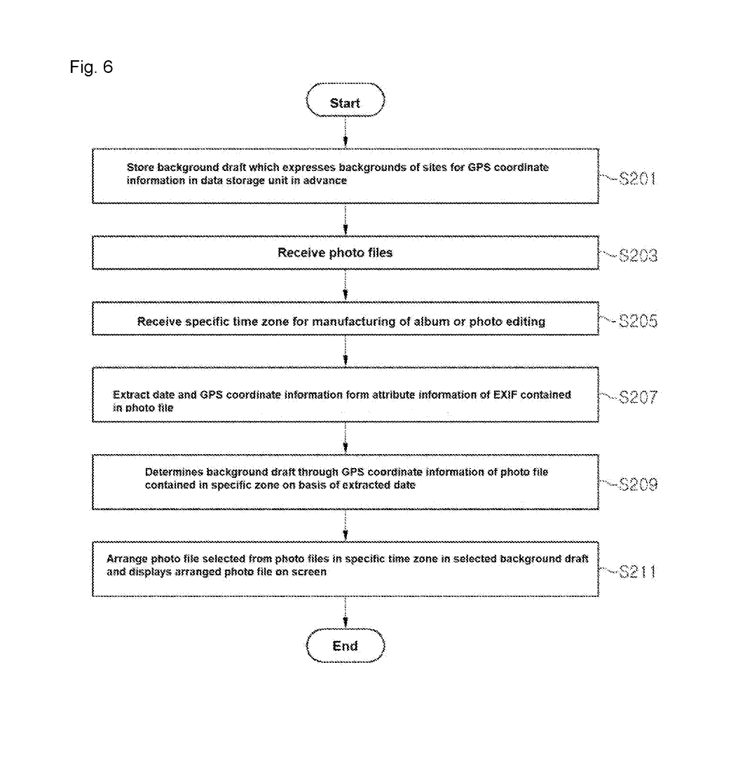

FIG. 5 is a block diagram illustrating a photo file editing apparatus according to another embodiment of the present invention.

Referring to FIG. 5, the photo file editing apparatus according the second embodiment of the present invention includes an information input unit 11 for inputting information such that a service related to the present invention may be performed, an interface unit 12 which transmits and receives information related to the present invention, a display unit 13 which displays the information related to the present invention, a data storage unit 14 which stores the information related to the present invention, and a central processing unit 15 which arranges a photo file of a specific time zone in a background draft that expresses the background of a photographing site in the specific time zone and displays the arranged photo file on a screen.

The photo file editing apparatus according to the second embodiment of the present invention may be a mobile communication terminal equipped with a GPS receiver and a camera.

The information input unit 11 is a means for inputting a photo file that is to be used for editing. The photo file is a photo file stored in a digital photographing device or a mobile communication terminal equipped with a GPS receiver.

Further, the information input unit 11 receives a control command for selecting a photo file, and a control command for selecting a background draft. Further, the information input unit 11 receives a range for designating a photo file of a specific time zone for manufacturing of an album or photo editing.

The interface unit 12 provides a background draft received from a draft providing server (not illustrated) which provides a background draft or a photo file editing server 300 (FIG. 1), to the central processing unit 15. Here, the background draft has a structure for variously arranging several photo files, and the sizes of the photo files also are adjusted and arranged according to the structure. The background draft has various arrangement structures which may express a site of GPS coordinate information, and the arrangement structure may contain an image, by which a photographing site may be identified or indirectly felt, in an arbitrary area, or may contain an image obtained by photographing a site of the GPS coordinate information as illustrated in FIG. 7. In the image illustrated in FIG. 7, several photo files may be arranged to overlap the image.

The data storage unit 14 stores a background draft received through the interface unit 12. Further, the data storage unit 14 temporarily stores a photo file, which is to be used for manufacturing of an album or photo editing.

The central processing unit 15 extracts a date of an original copy and GPS coordinate information from attribute information of EXIFs contained in the photo files, arranges the photo files with reference to the extracted date, displays, among the arranged photo files, a photo file contained in a specific time zone on a reduction image screen and searches the background draft set in the GPS coordinate information of the photo file contained in the specific time zone from the data storage unit 14 to arrange the photo file selected automatically or manually in the discovered background draft and displays the arranged photo file on a screen at the same time.

In more detail, the central processing unit 15 extracts a date of the original copy and GPS coordinate information, from the attribute information of the EXIF contained in the photo file input through the information input unit 11.

Thereafter, the central processing unit 15 selects photo files in a desired specific time zone for manufacturing of an album or editing of a photo on the basis of the extracted date, and automatically selects, among the selected photo files, a photo file, which is to be used for editing, according to a selection reference condition or receives the selected photo files through the information input unit 11 to select a photo file, which is to be used for editing. The preset selection reference condition may include a clear photo file and the size of a photo file.

The central processing unit 15 may display background drafts stored in the data storage unit 14 on the display unit 13, and may reset, among the displayed background drafts, the background draft, to which the photo file is to be applied, through the information input unit 11. According to a request of the user, the central processing unit 15 may set a background draft that is close to the location and the direction contained in the GPS coordinate information of the photo file and the date of the corresponding photo file when there is automatic setting of a background draft, and may set a desired background draft according to the taste of the user when there is a request for manual setting of a background draft.

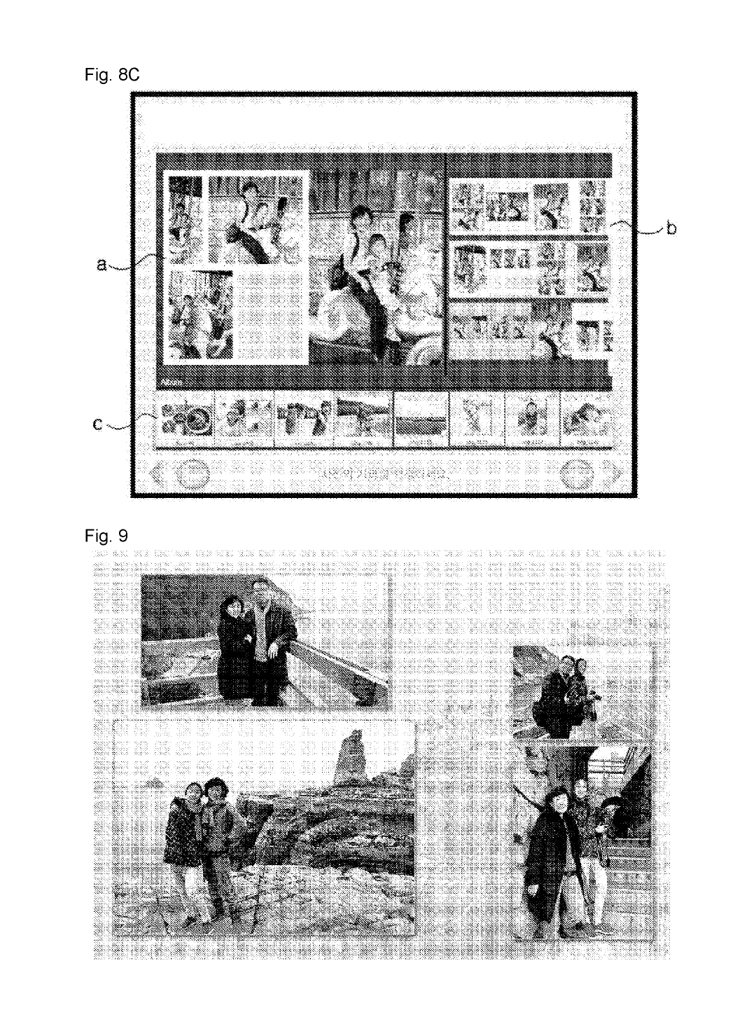

The central processing unit 15 arranges photo files in the automatically or manually set background draft and displays the arranged photo files on the display unit 13. Then, the photo files arranged in the selected background draft are displayed in a predetermined display area, that is, an area as well illustrated in FIG. 8C. FIG. 8A illustrates, for example, selected three photo files. FIG. 8B illustrates a background draft which is to be applied to selected photo files. FIG. 8C illustrates a photo in which the photo files illustrated in FIG. 8A are arranged in the background draft illustrated in FIG. 8B.

As illustrated in FIG. 8C, a user interface (UI) displayed on the display unit 13 includes a draft screen (a), a preliminary draft screen (b), a thumbnail screen (c) by which a photo file may be previewed, and the draft screen is a part which displays the photo files arranged in the background draft selected through the information input unit 11 in a predetermined area, and is one of the photo files in the form of a thumbnail. The preliminary draft screen is a part in which photo files displayed in the draft screen or other photo files around the draft screen are arranged in a predetermined preliminary draft to be displayed. The thumbnail may inform at which location the photo files located in the draft screen and the preliminary draft are located.

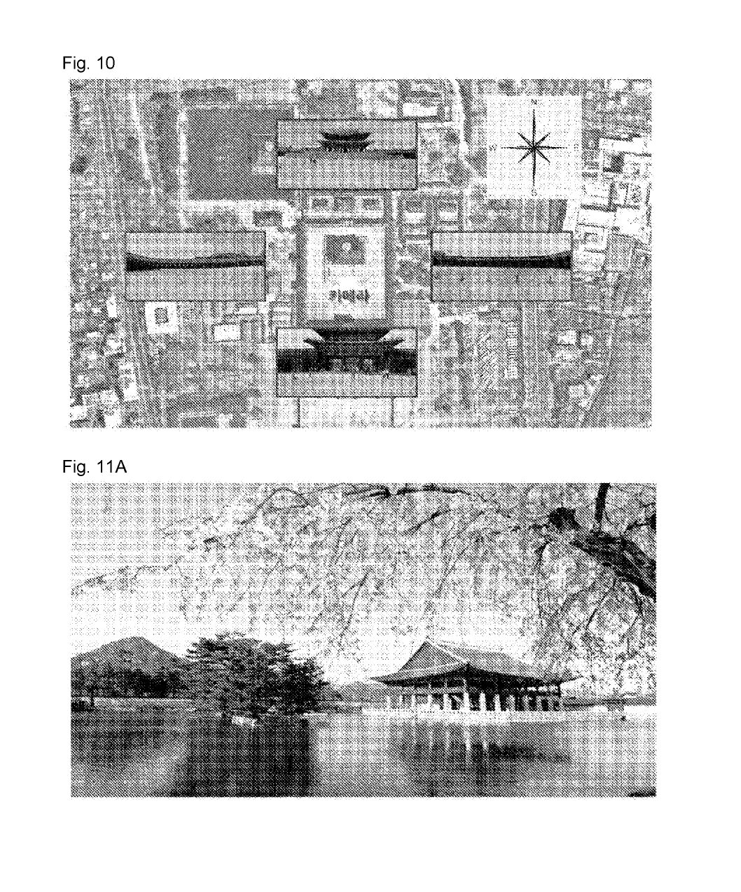

Further, the central processing unit 15 may arrange the selected photo files in the background draft, and may provide guide information for explaining a site of GPS coordinate information in an arbitrary area as illustrated in FIG. 9.

By doing this, since the photo files captured in a specific time zone are arranged in the background draft which may express a photographing site in a specific time zone to be provided without connection to the photo file editing server, a sense of realism of the photo can be felt more.

A photo editing method using GPS coordinate information in a photo file editing apparatus according to the second embodiment of the present invention will be described as follows.

First, the central processing unit 15 stores a background draft which expresses the backgrounds of sites for GPS coordinate information in the data storage unit 14 in advance (S201). Then, the background draft is a structure for arranging photo files, and several photo files may be arranged in one photo.

In the present embodiment, images which express the backgrounds of the sites for GPS coordinates are included in the background draft such that the sense of realism and the touch of the photo may be felt by expressing the feature of the photographing sites.

The central processing unit 15 receives photo files through the information input unit 11 (S203). Before receiving the photo files, the central processing unit 15 downloads a program (for example, an app) for photo editing from the photo file editing server 300 (FIG. 1). and a main screen for manufacturing of an album or photo editing is displayed on a screen if the downloaded program is executed. If a request for manufacturing of an album or photo editing is made on the main screen, a photo file is input or a plurality of photo files are input through selection of the location of a folder in which the photo files are stored.

Then, the central processing unit 15 receives a specific time zone for manufacturing of an album or photo editing (S205).

The central processing unit 15 extracts a date and GPS coordinate information form attribute information of the EXIF contained in the photo file input through the information input unit 11 (S207). Here, although it has been described in the sequence of extracting the data and GPS coordinate information contained in the photo file after receiving the specific time zone, the present invention is not limited to the sequence and it is implementable to receive a specific time zone and extract a date and GPS coordinate information from attribute of an EXIF contained in a photo file of a specific time zone in step S209, which will be described below.

The central processing unit 15 determines a background draft through GPS coordinate information of a photo file contained in a specific zone on the basis of the extracted date (S209). The background draft is a background draft set in GPS coordinate information which is close to GPS coordinate information of a photo file contained in a specific time zone, and a background draft which expresses the background of a photographing site in a specific time zone may be selected with reference to background drafts for the GPS coordinate information stored in the data storage unit 15 or a background draft corresponding to GPS coordinate information which is close to the GPS coordinate information and on which a season containing a date is reflected may be selected

The central processing unit 15 arranges a photo file selected from the photo files in a specific time zone in the selected background draft and displays the arranged photo file on a screen (S211). Here, although it has been described that the selected photo file is arranged in the background draft and is displayed, the selected photo file may be arranged in the background draft, on which a specific season with reference to the extracted data is reflected, and guide information for explaining a site of GPS information corresponding to the photographing site may further provided in an arbitrary area of the photo in which the selected photo file is arranged in the background draft.

Accordingly, the sense of realism and the touch of the photo can be given by arranging the photo files in the background draft which expresses the background of the photographing site and displaying the arranged photo files.

The present invention is not limited by the embodiments and may be variously modified and changed by those skilled in the art, and the modifications and changes are included in the purposes and range of the present invention defined by the claims.

### INDUSTRIAL APPLICABILITY

The present invention relates to a photo editing method using GPS coordinate information, and can give the sense of realism and a touch to the user by arranging photo files in a background draft associated with a photographing site in a specific time band.

1. A photo file editing method using GPS coordinate information, the method using a photo file editing server including a draft database which stores a draft having a structure in which a plurality of photo files are arranged in one photo, the method comprising:
receiving, via an information communication network, one or more photo files selected by a user terminal, by the photo file editing server;
receiving a range of, among the received one or more photo files, photo files captured in a specific time band from the user terminal, by the photo file editing server;
extracting a date and GPS coordinate information contained in the received one or more photo files, and selecting a photo file pertaining to the received range of the specific time band of the extracted date, by the photo file editing server; and
arranging the selected photo file in, among background drafts stored in the draft database, a background draft set to GPS coordinate information, which is closed to the extracted GPS coordinate information, and providing the arranged photo file, by the photo file editing server.

2. The method of claim 1, wherein the selecting of the photo file includes:
automatically selecting, among the photo files pertaining to the received range of the specific time band, a photo file which is to be used for editing, according to a preset selection reference condition, or selecting a photo file selected through the user terminal, by the photo file editing server.

3. The method of claim 1, wherein the draft database stores a background draft in which an image which matches with arbitrary GPS coordinate information to express a site of the corresponding GPS coordinate information is included in an arbitrary area, and
wherein the providing of the arranged photo file includes:
searching for GPS coordinate information which is closest to a longitude, a latitude, and a direction of the extracted GPS coordinate information from the draft database, matching the discovered GPS coordinate information, and arranging the selected photo file in the stored background draft.

4. The method of claim 1, wherein the receiving of the one or more photo files includes:
receiving a photo file captured through an electronic terminal equipped with a GPS receiver and a camera from the user terminal, or receiving the captured photo file from the user terminal equipped with the GPS receiver and the camera.

5. The method of claim 1, wherein the providing of the arranged photo file includes:
transmitting the photo in which the photo file is arranged in the background draft to the user terminal via the information communication network.

6. The method of claim 1, wherein the draft database stores, for each season, a background draft in which an image which matches with arbitrary GPS coordinate information to express a site of the corresponding GPS coordinate information is included, and
wherein the providing of the arranged photo file includes:
searching for GPS coordinate information which is closest to the extracted GPS coordinate information from the draft database, matching the discovered GPS coordinate information, and arranging the selected photo file in, among the stored background drafts, a background draft on which a determined season is reflected, on the basis of the extracted date.

7. The method of claim 1, wherein the draft database stores a background draft in which an image which matches with arbitrary GPS coordinate information to express a site of the corresponding GPS coordinate information is included and guide information for explaining a site of the background draft, and
wherein the providing of the arranged photo file includes:
providing the guide information for explaining a site of the GPS coordinate information to an arbitrary area of the background draft in which the selected photo file is arranged.

8. A photo file editing method using GPS coordinate information, the method being used for a photo file editing apparatus having a data storage unit which stores background drafts, the method comprising:
receiving a range of, among one or more photo files, photo files captured in a specific time band, by a central processing unit;
extracting a date and GPS coordinate information contained in the one or more photo files, and selecting a photo file pertaining to the received range of the specific time band of the extracted date, by the central processing unit; and
arranging the selected photo file in, among background drafts stored in the data storage unit, a background draft set to GPS coordinate information, which is closed to the extracted GPS coordinate information, and providing the arranged photo file, by the central processing unit.

9. The method of claim 8, wherein the selecting of the photo file includes:
displaying a photo file pertaining to the received range of the specific time band on a thumbnail screen, by the central processing unit; and
automatically selecting, among the photo files displayed on the reduction image screen, a photo file which is to be used for editing, according to a preset selection reference condition, or selecting a photo file selected through the user terminal, by the central processing unit.

10. The method of claim 9, wherein the data storage unit stores a background draft in which an image which matches with arbitrary GPS coordinate information to express a site of the corresponding GPS coordinate information is included in an arbitrary area, and
wherein the providing of the arranged photo file includes:
searching for GPS coordinate information which is closest to a longitude, a latitude, and a direction of the extracted GPS coordinate information from the draft database, matching the discovered GPS coordinate information, arranging the selected photo file in the stored background draft, and displaying the arranged photo file on a screen.

11. The method of claim 8, wherein the data storage unit stores, for each season, a background draft in which an image which matches with arbitrary GPS coordinate information to express a site of the corresponding GPS coordinate information is included, and
wherein the providing of the arranged photo file includes:
searching for GPS coordinate information which is closest to the extracted GPS coordinate information from the draft database, matching the discovered GPS coordinate information, and arranging the selected photo file in, among the stored background drafts, a background draft on which a determined season is reflected, on the basis of the extracted date.

12. The method of claim 8, wherein the data storage unit stores a background draft in which an image which matches with arbitrary GPS coordinate information to express a site of the corresponding GPS coordinate information is included and guide information for explaining a site of the background draft, and
wherein the providing of the arranged photo file includes:
providing the guide information for explaining a site of the GPS coordinate information to an arbitrary area of the background draft in which the selected photo file is arranged.
